(19) United States
(12) Patent Application Publication
(10) Pub. No.: US 2006/0267754 A1
(43) Pub. Date: Nov. 30, 2006

(54) Data collection apparatus

(75) Inventors: Kazumi Takeda, Tokyo (JP); Kenji Murakami, Tokyo (JP); Shunji Sugiyama, Tokyo (JP); Shinya Uchida, Tokyo (JP); Masaaki Yonezawa, Tokyo (JP)

Correspondence Address: SUGHRUE MION, PLLC, 2100 PENNSYLVANIA AVENUE, N.W., SUITE 800, WASHINGTON, DC, 20037, US

(73) Assignees: YOKOGAWA ELECTRIC CORPORATION; YOKOGAWA METERS & INSTRUMENTS CORPORATION

(21) Appl. No.: 11/431,617

(22) Filed: May 11, 2006

(30) Foreign Application Priority Data
May 30, 2005 (JP) P. 2005-156762

(51) Int. Cl. G08B 29/00

(52) U.S. Cl. 340/506

(57) ABSTRACT

A data collection apparatus enables to connect to a support center via a network. The data collection apparatus has a measuring section which measures a physical quantity, a data storing section which stores measurement data obtained by the measuring section, in association with at least one of sound data and image data, a data communicating section which transmits and receives data to and from the support center, and an outputting section which reproduces and displays the transmitted and received data.

### CROSS-REFERENCE TO RELATED APPLICATIONS

This application is based upon and claims the benefit of priority from the prior Japanese Patent Applications No. 2005-156762, filed on May 30, 2005, the entire contents of which are incorporated herein by reference.

### BACKGROUND OF THE INVENTION

1. Field of the Invention

The present invention relates to a data collection apparatus which has high affinity with a network, and which is suitably used for maintenance services of various kinds of apparatuses constituting building equipment or a control plant.

2. Description of the Related Art

As the maintenance of building equipment, for example, it has been proposed to use a mobile or portable data collection apparatus as disclosed in JP-A-2001-265823 and JP-A-2002-287819.

JP-A-2001-265823 discloses a system configuration in which plural kinds of measurement data are collected and consolidated together with time data, and various analyses are performed by a personal computer.

JP-A-2002-287819 discloses a system configuration in which plural kinds of measurement data are efficiently collected so as to enhance analysis accuracy, the collected data are transmitted to a distant place, operation data are efficiently collected for an intermittently operative apparatus, and the collected data are monitored or observed via the Internet.

JP-A-2001-265823 is referred to as a related art.

JP-A-2002-287819 is also referred to as the related art.

FIG. 4 is a diagram of an example of a related-art system configuration in a maintenance work for various apparatuses which constitute a control plant. A maintenance worker carries a data collection apparatus 2 which is connectable to the Internet 1, and then goes to the site of a control plant 4 in which an apparatus to be maintained 3 is installed. At this time, the maintenance worker often carries a paper document file 5 such as a connection diagram of the apparatus to be maintained 3, an installation diagram of the apparatus to be maintained, and an operation manual of the apparatus to be maintained, a recording medium in which these documents are electronically filed and stored, a personal computer 6 for reading out the electronically filed documents from the recording medium and displaying them, and the like. Additionally, a portable telephone 7 is carried.

Also a data center 8 for storing measurement data related to the apparatus to be maintained 3 which are collected and transferred by the data collection apparatus 2, and a support center 9 for supporting a user of the apparatus to be maintained 3 and a maintenance worker are connected to the Internet 1.

FIG. 5 is a block diagram showing an example of the data collection apparatus 2 as a related art. The data collection apparatus 2 is configured by: an operation section 10 which performs various operations required for a predetermined maintenance work; a display section 11 which displays information related to the operation, and present and past measurement data related to the apparatus to be maintained 3 in the form of numerals and graphs; a signal input section 12 which measures various kinds of input signals related to the apparatus to be maintained 3, and converts the input signals into measurement data; a data storing section 13 which stores the measurement data converted by the signal input section 12; a communication interface 14 which communicates with the data center 8 via the Internet 1; an external memory 15 which transfers and stores the data of the data storing section 13; a CPU 16 which collectively manages the operation of the whole data collection apparatus 2; and the like.

When power supply voltages of three apparatuses to be maintained A, B, and C installed in the site are to be measured and checked as the maintenance work, for example, the worker first specifies the apparatuses to be maintained A, B, and C from the installation diagram of the site, and determines the work route (for example, B→C→A) for efficiently performing the measurement. In some cases, terminals from which the power supply voltage can be measured are varied depending on the apparatus to be maintained. Therefore, the worker reads out and determines the corresponding measurement terminals from the respective connection diagrams of the apparatuses to be maintained A, B, and C. Then, the power supply voltages are actually measured for the respective apparatuses to be maintained A, B, and C, and the measured results are recorded. The measured values are judged whether they are in the allowable range or not. If the measured value indicates an abnormal value outside the allowable range, the reason is determined and clarified. If the voltage is in an adjustable range, the voltage is adjusted to be a normal voltage. In the case where repair can be performed, a required action such as replacement of components is conducted.

When, in such a maintenance work, the worker has little experience or comes to the site at the first time, it is sometimes difficult to perform sufficient works based only on the installation diagram of the site and connection diagram of the apparatus to be maintained 3 which are displayed on the display section 11 of the data collection apparatus 2.

Depending on the maintenance work, it is necessary to record the site conditions of the apparatus to be maintained 3, so that also a camera must be carried.

When the maintenance worker who comes to the site is to judge whether an operation error of the data collection apparatus 2 occurs or not, it is necessary for the worker to remember the operation procedure of the data collection apparatus 2 performed by the worker at the site, and to inform a maintenance manager in the support center 9 of the operation procedure via the telephone 7. Therefore, a large number of processes are required, and the operation procedure may be mistakenly transmitted.

### SUMMARY OF THE INVENTION

An object of the invention is to provide a data collection apparatus which has high affinity with a network, and which can efficiently perform a high quality maintenance work on an apparatus to be maintained.

The invention provides a data collection apparatus which enables to connect to a support center via a network, having:

a measuring section which measures a physical quantity;

a data storing section which stores measurement data obtained by the measuring section, in association with at least one of sound data and image data;

a data communicating section which transmits and receives data to and from the support center; and

an outputting section which reproduces and displays the transmitted and received data.

In the data collection apparatus, the support center has an apparatus management data storing section which stores at least one of various kinds of management data including connection diagrams, installation diagrams, operation manuals, and version-up information of an apparatus to be maintained and the data collection apparatus, and information of toxic substances in discarding the apparatus.

The data collection apparatus further has an operation history storing section which stores an operation history of the data collection apparatus.

In the data collection apparatus, the support center reproduces operations performed to the data collection apparatus, based on operation history data transmitted from the data collection apparatus.

The data collection apparatus further has a work progress management data storing section which stores work progress management data.

In the data collection apparatus, the data collection shares work progress management data of other data collection apparatus each other via the support center.

According to the data collection apparatus, it is possible to obtain a data collection apparatus which has high affinity with a network, and which can efficiently perform a high quality maintenance work on an apparatus to be maintained.

### BRIEF DESCRIPTION OF THE DRAWINGS

FIG. 1 is a diagram of an example of the system configuration of the invention;

FIG. 2 is a block diagram showing a specific example of a data collection apparatus 17;

FIG. 3 is an appearance configuration diagram showing the specific example of the data collection apparatus 17;

FIG. 4 is a diagram of an example of a related-art system configuration; and

FIG. 5 is a block diagram showing an example of a data collection apparatus 2 as a related art.

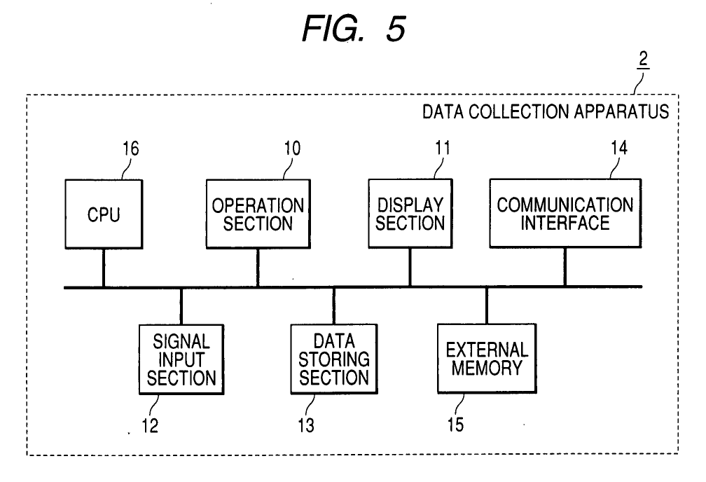

### DETAILED DESCRIPTION OF THE PREFERRED EMBODIMENTS

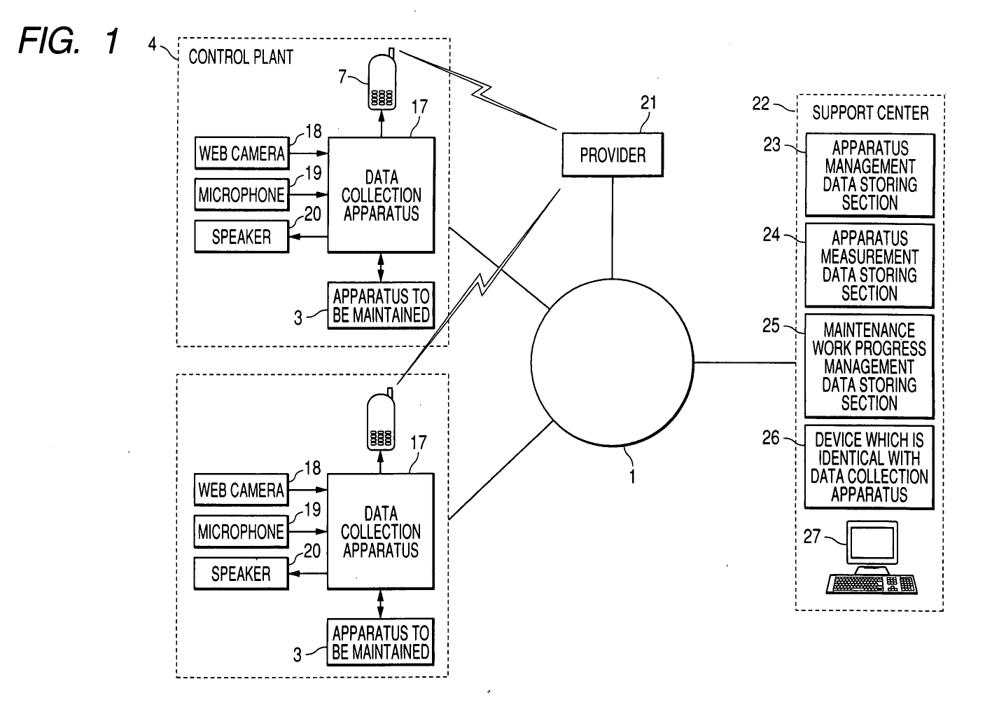

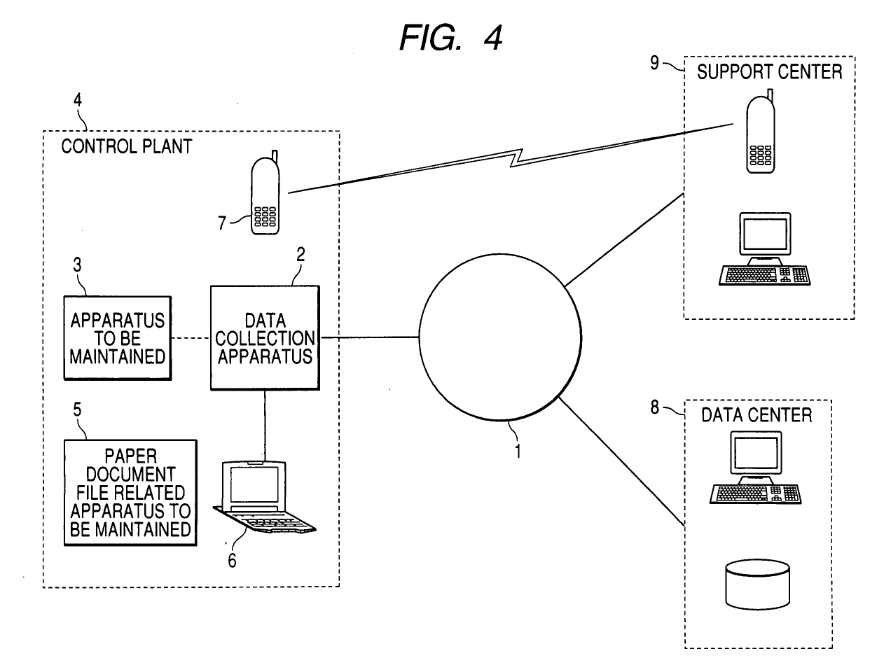

An embodiment according to the invention will be described in detail with reference to the accompany drawings. FIG. 1 is a diagram of an example of the system configuration of the invention in a maintenance work for various apparatuses constituting a control plant. The components identical with those of FIG. 4 are denoted by the same reference numerals.

A maintenance worker carries a data collection apparatus 17 capable of being connected to the Internet 1, and goes to the site of a control plant 4 in which an apparatus to be maintained 3 is installed. At this time, the maintenance worker does not carry paper document files such as a connection diagram, installation diagram, and operation manual of the apparatus to be maintained 3, a recording medium on which these documents are electronically filed and stored, and a personal computer which is means for reading out the electronically filed documents from the recording medium and displaying them. The portable telephone 7 is carried to be used for packet communication.

To the data collection apparatus 17, a web camera 18 for shooting and inputting image data of the work site, a microphone 19 for inputting sound data, and a speaker 20 for reproducing the sound data are connected depending on the conditions of the apparatus to be maintained 3.

A provider 21 for performing packet communication through the portable mobile phone 7, and a support center 22 for supporting a user of the apparatus to be maintained 3 and a maintenance worker are connected to the Internet 1.

In the support center 22, disposed are: an apparatus management data storing section 21 which stores management data in which various documents such as a connection diagram of the apparatus to be maintained 3 and the data collection apparatus 17, an installation diagram, an operation manual, version-up information, and toxic substances information in discarding the apparatus are electronically filed; an apparatus measurement data storing section 24 which stores measurement data of the apparatus to be maintained 3; a maintenance work progress management data storing section 25 which stores the progress management data of the maintenance work for each data collection apparatus 17; a device 26 which is identical with the data collection apparatus 17; a personal computer 27; and the like. In the support center 22, a control supervisor for supporting a maintenance worker who goes to the site is always stationed.

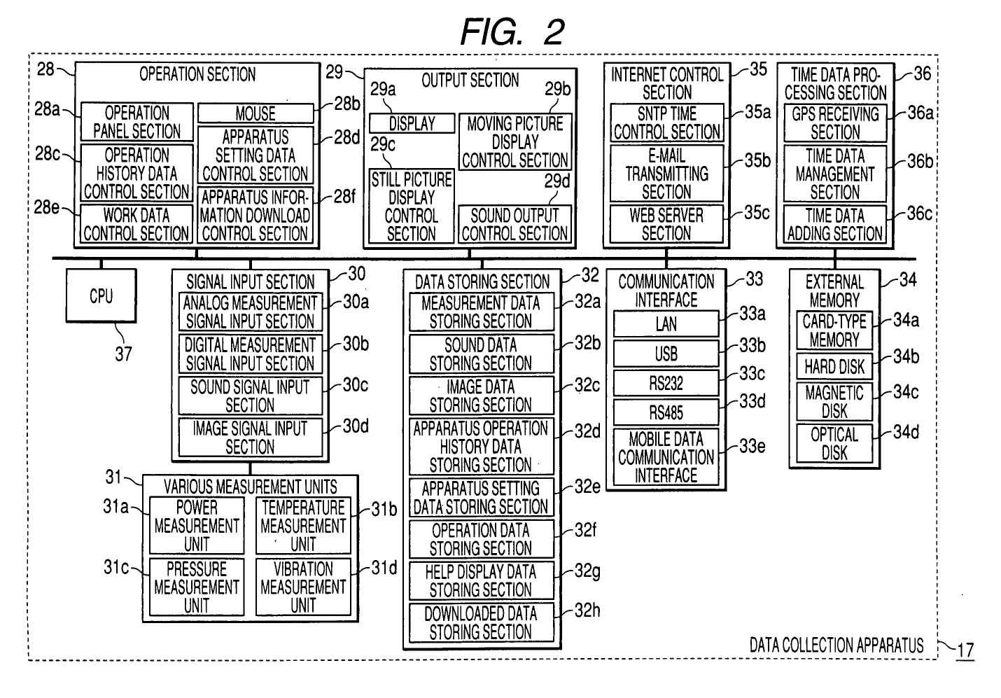

FIG. 2 is a block diagram showing a specific example of the data collection apparatus 17. The data collection apparatus 17 is configured by: an operation section 28 which executes various operations of the data collection apparatus 17 and the apparatus to be maintained 3 required for a predetermined maintenance work; a display section 29 which displays information related to the operations of the data collection apparatus 17 and the apparatus to be maintained 3, and present and past measurement data related to the apparatus to be maintained 3, in the form of numerals and graphs; a signal input section 30 which converts measurement signals related to various physical quantities such as a voltage, a current, a temperature, a pressure, vibration, and the like related to the apparatus to be maintained 3, into measurement data; measurement units 31 which output measurement signals related to the various physical quantities, and which are detachably connected to the signal input section 30; a data storing section 32 which stores the measurement data converted by the signal input section 30; various communication interfaces 33 which communicate with the external via various networks such as the Internet; various external memories 34 which transfer and store the data of the data storing section 32; an Internet control section 35 which controls the connection to the Internet; a time data processing section 36 which performs the processing related to the time inside the data collection apparatus 17; a CPU 37 which collectively manages the operation of the whole data collection apparatus 17; and the like.

The operation section 28 is configured by: an operation panel section 28a in which various switches and buttons for performing the setting of measurement conditions, the switching of the display selection, and the like are disposed; a mouse 28b; an operation history data control section 28c which controls the writing and reading of the operation history data of the data collection apparatus 17; an apparatus setting data control section 28d which controls the writing and reading of various data of the measurement conditions, parameters, and the like that are set in the data collection apparatus 17 and the apparatus to be maintained 3; a work data control section 28e which controls the writing and reading of the data related to the maintenance work performed by using the data collection apparatus 17; an apparatus information download control section 28f which controls the download of the electronically filed management data such as the connection diagram, the installation diagram, and the operation manual related to the apparatus to be maintained 3 from the apparatus management data storing section 23 of the support center 22; and the like.

The output section 29 configured by: a display 29a of liquid crystal or the like; a moving picture display control section 29b which controls moving picture information downloaded from the web camera 18 or the support center 22 to be displayed on the display 29a; a still picture display control section 29c which controls the electronically filed management data information such as the connection diagram, the installation diagram, and the operation manual related to the apparatus to be maintained 3, numerical values and graphs of the present and past measurement data, e-mails, and the like to be displayed; a sound output control section 29d which drives a speaker 20; and the like.

The signal input section 30 is configured by: an analog measurement signal input section 30a; a digital measurement signal input section 30b; a sound signal input section 30c; an image signal input section 30d; and the like.

As the various measurement units 31, various physical quantity measurement units such as a power measurement unit 31a, a temperature measurement unit 31b, a pressure measurement unit 31c, and a vibration measurement unit 31d are detachably connected.

The data storing section 32 is configured by a measurement data storing section 32a, a sound data storing section 32b, an image data storing section 32c, an apparatus operation history data storing section 32d, an apparatus setting data storing section 32e, an operation data storing section 32f, a help display data storing section 32g, a downloaded data storing section 32h, and the like.

The communication interface 33 is configured by a LAN interface 33a, a USB interface 33b, an RS232 interface 33c, an RS485 interface 33d, a mobile data communication interface 32e, and the like.

As the external memory 34, useful are a card-type memory 34a, a hard disk 34b, a magnetic disk 34c, an optical disk 34d, and the like.

The Internet control section 35 is configured by an SNTP time control section 35a, an e-mail transmitting section 35b, a Web server section 35c, and the like.

The time data processing section 36 is configured by: a GPS receiving section 36a; a time data management section 36b which manages the time data inside the data collection apparatus 17; a time data adding section 36c which adds time data to various data stored in the data storing section 32; and the like.

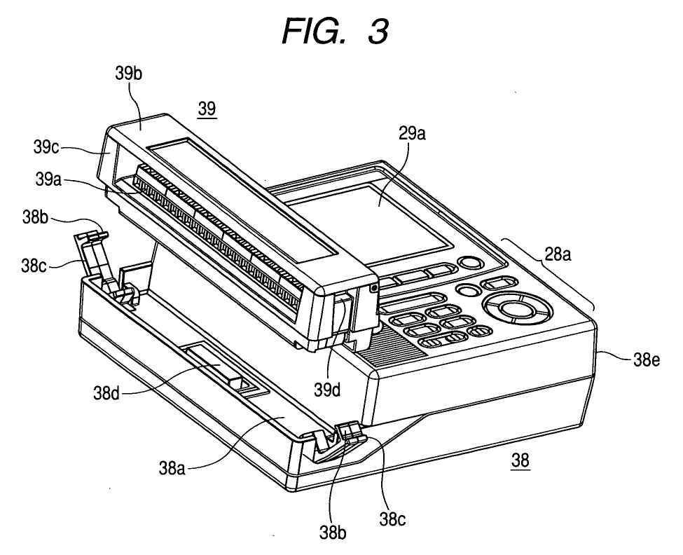

FIG. 3 is an appearance configuration diagram showing the specific example of the data collection apparatus 17. The components corresponding to those of FIG. 2 are denoted by the same reference numerals. As shown in FIG. 3, the data collection apparatus 17 is configured by a body 38, and a terminal case 39 which is detachably attached to one side of a front section of the body 38, and which corresponds to a measurement unit.

An attachment portion 38a for the terminal case 39 is formed in the vicinity of the one side of the front portion of the main body 38. At both ends of the attachment portion 38a, fixing members 38c having projections 38b for fitting to both ends of the terminal case 39 so as to fix the terminal case 39 are swingably attached. A connector 38d for electrically connecting and mechanically coupling a terminal plate 39a accommodated in the terminal case 39 is disposed in a middle portion of the attachment portion 38a.

To an upper portion of the terminal case 39, a cover 39b is attached via a hinge in an openable and closable manner. One side face 39c of the terminal case 39 is opened as a connection port for wirings. Engagement pieces 39d with which the projections 38b of the fixing member 38c are to be engaged are disposed at both ends of the terminal case 39.

The display 29a is disposed in an upper portion of the front portion of the main body 38, and the operation panel section 28a is disposed in a lower portion.

In a side face opposite to the attachment portion 38a of the main body 38 and for the terminal case 39, a slot for various memory cards, terminals for various communications such as LAN, RS232, RS485, and USB, a trigger terminal, an AC adopter terminal, a power switch, and the like are disposed.

A housing portion of a screwdriver for operating screws of the terminal plate, and a housing portion of a battery for driving the apparatus are disposed in a bottom face of the main body 38.

In a state where the terminal case 39 is mounted, a detachable rubber boot which is hot shown, and which is used for improving the shock resistance is attached to an outer circumference of the body 38 excluding the front face, if necessary.

The body 38 and the terminal case 39 are configured as a dust-proof and drip-proof structure which is complied with the standard of IP41 by JEM (Japan Electrical Manufacturer's Association).

The operation procedure of a maintenance work by using the thus configured data collection apparatus 17 will be described.

When a maintenance worker is informed of unique identification information of the apparatus to be maintained 3 for specifying the apparatus to be maintained 3 as a target of the maintenance work, the maintenance worker operates the operation section 28 of the data collection apparatus 17 before going to the site, so as to connect the apparatus to the support center 22 via the Internet 1. After the completion of a predetermined personal certification procedure, the identification information which is unique to the apparatus to be maintained 3 is input.

When the support center 22 receives and certifies the identification information which is unique to the apparatus to be maintained 3, the support center 22 allows the maintenance worker to access the apparatus management data storing section 23. Then, image data such as a map showing the vicinity of the business establishment in which the apparatus to be maintained 3 with the unique identification information is installed, and a specific layout drawing of the apparatus to be maintained 3 in the business establishment are transmitted to the data collection apparatus 17 via the Internet 1. An identifier (icon) which clearly specifies the business establishment is added to the map image data, and an identifier (icon) which clearly specifies the apparatus to be maintained 3 is added to the layout drawing.

When the data collection apparatus 17 receives the image data transmitted from the support center 22, the data collection apparatus displays the data on the display 29a based on the control of the apparatus information download control section 28f, and stores the data into the image data storing section 32c, as required.

Accordingly, the maintenance worker can accurately comprehend and understand the installation site of the apparatus to be maintained 3 which is the target of the specified maintenance work, from the display screen of the data collection apparatus 17, so that the maintenance worker can rapidly reach the target apparatus to be maintained 3 without any mistake in the installation site in which many apparatuses are disposed. For example, a wireless tag in which unique identification information assigned to each apparatus to be maintained 3 is written is attached to the respective apparatus to be maintained 3. Before the start of the work at the site, the identification information written in the wireless tag is read by means of the data collection apparatus 17 by the maintenance worker, so as to confirm the agreement, whereby false recognition can be prevented from occurring.

The support center 22 consolidates the identification information unique to the apparatus to be maintained 3 and the data collection apparatus 17, the map showing the vicinity of the business establishment in which the apparatus to be maintained 3 is installed, the specific layout drawing of the apparatus to be maintained 3 in the business establishment, the version-up information of the apparatus, the toxic substances information when the apparatus is discarded, and the like in association. Therefore, the maintenance worker can always obtain the latest information related to the apparatus to be maintained 3 and the data collection apparatus 17.

At the site, when the maintenance worker operates the data collection apparatus 17 to start the maintenance work, a sequence of operation history of the data collection apparatus 17 is stored in the apparatus operation history data storing section 32d on the basis of the control of the operation history data control section 28c.

All of the series of setting data of the data collection apparatus 17, and, if necessary, the setting data for the apparatus to be maintained 3 are stored in the apparatus setting data storing section 32e on the basis of the control of the apparatus setting data control section 28d.

In addition, the progress conditions of the maintenance work for the apparatus to be maintained 3 by using the data collection apparatus 17 are sequentially stored in the work data storing section 32f at every completion of work items which are previously set in accordance with the apparatus to be maintained 3, by the control of the work data control section 28e. The progress condition data of the maintenance work for the apparatus to be maintained 3 stored in the work data storing section 32f are also transferred to and stored in the maintenance work progress management data storing section 25 in the support center 22 for each data collection apparatus 17.

The various measurement units 31 of the data collection apparatus 17 measure physical quantities such as an electric power, a temperature, a pressure, and vibration related to the maintenance of the apparatus to be maintained 3, and the results are input into the signal input section 30.

The analog and digital measurement signals supplied from the various measurement units 31, and also image signals output from the web camera 18 and sound signals output from the microphone 19 are input to the signal input section 30. All of these signals are converted as measurement data.

Time data is added to the measurement data on the basis of the control of the time data adding section 36c, and then the measurement data are stored in the measurement data storing section 32a. The accuracy of the time data is maintained to be high based on the management of the time data management section 36b, by using the time data obtained from the SNTP time control section 35a and the GPS receiving section 36a.

These measurement results are listed or graphed in accordance with the applications, and displayed on the display 29a based on the control of the still picture display control section 29c. The measurement results are transmitted to a predetermined destination as text data or attached files, based on the control of the e-mail transmitting section 35b. As required, the measurement result screen is written in Web-based format and opened on the Internet 1 on the basis of the control of the Web server section 35c.

In the case where the apparatus to be maintained 3 accompanies the mechanical motion, for example, the image signal by the web camera 18 and the sound signal by the microphone 19 are recorded in synchronization with the measurement data by the measurement units 31. When either of the image signal and the sound signal or the measurement data is judged to be abnormal, the other signal preceding, succeeding, and including the time when the phenomenon occurs can be referred. Thus, as compared with the case where the cause analysis is performed by using a single signal, more accurate judgment can be expected.

In the case where the maintenance worker who goes to the site is not familiar with the operation of the apparatus to be maintained 3 or the data collection apparatus 17, images of the operation conditions taken by the web camera 18 are transmitted to the support center 22 and monitored by the control supervisor, so that appropriate instructions can be obtained for the operation of the camera.

The microphone 19 can be used also as a voice memo in which, for example, a phenomenon that is noted by the maintenance worker during the maintenance work can be recorded in the form of a voice.

As required, the maintenance worker who goes to the site can check the general operation of the data collection apparatus 17, at any time, by displaying the information stored in the help display data storing section 32g on the display 29a.

When the circuit diagrams of the apparatus to be maintained 3 and the data collection apparatus 17, the manual for maintenance work, the version-up information, the toxic substances information when the apparatus is discarded, and the like are to be checked, the support center 22 is accessed via the Internet 1, and the information is downloaded to be displayed on the display 29a. Therefore, the work can be efficiently performed.

When a desired result is not obtained from a series of collected measurement data related to the maintenance of the apparatus to be maintained 3 and the maintenance worker at the site cannot deal with the conditions, the maintenance worker can receive instructions from the control supervisor who is always stationed in the support center 22.

The control supervisor instructs the maintenance worker at the site to transmit via the Internet 1 at least data judged as required for analysis among the measurement data stored in the measurement data storing section 32a, the sound data stored in the sound data storing section 32b, the image data stored in the image data storing section 32c, the apparatus operation history data stored in the apparatus operation history data storing section 32d, and the apparatus setting data stored in the apparatus setting data storing section 32e. When an operation error of the data collection apparatus 17 is presumed, for example, the transmitted operation history data is reflected on the data collection device 26 in the support center 22, so that a stage in which the operation error occurs can be reproduced and checked up. Therefore, it is possible to give specific advices and instructions to the maintenance worker.

In the maintenance work at the site in which many apparatuses to be maintained 3 are installed, a team including a plurality of workers with the respective data collection apparatus 17 may come to the site, and the maintenance work may be shared and performed in parallel. In such a case, the progress conditions of the maintenance work for each data collection apparatus 17 can be ascertained by making access to the maintenance work progress management data storing section 25 in the support center 22. If the work sharing is reviewed while the site conditions are reflected as required, the work efficiency as the team can be enhanced.

The communication between the data collection apparatus 17 and the external is not limited to the Internet 1 via the LAN interface 33a. Alternatively, depending on the application, a serial communication network through the RS232 interface 33c or the RS485 interface 33d may be used, or a mobile data communication interface 32e may be used.

As described above, according to the embodiment, it is possible to realize a data collection apparatus which has high affinity with the network, and which can efficiently perform a high-quality maintenance work for an apparatus to be maintained.

In addition, according to the embodiment, the measurement data, the sound data, and the image data can be synchronized with one another as required, so that the analysis accuracy for the apparatus to be maintained can be enhanced.

What is claimed is:

1. A data collection apparatus which enables to connect to a support center via a network, comprising:
a measuring section which measures a physical quantity;
a data storing section which stores measurement data obtained by the measuring section, in association with at least one of sound data and image data;
a data communicating section which transmits and receives data to and from the support center; and
an outputting section which reproduces and displays the transmitted and received data.

2. The data collection apparatus according to claim 1,
wherein the support center comprises an apparatus management data storing section which stores at least one of various kinds of management data including connection diagrams, installation diagrams, operation manuals, and version-up information of an apparatus to be maintained and the data collection apparatus, and information of toxic substances in discarding the apparatus.

3. The data collection apparatus according to claim 1, further comprising:
an operation history storing section which stores an operation history of the data collection apparatus.

4. The data collection apparatus according to claim 3,
wherein the support center reproduces operations performed to the data collection apparatus, based on operation history data transmitted from the data collection apparatus.

5. The data collection apparatus according to claim 1, further comprising:
a work progress management data storing section which stores work progress management data.

6. The data collection apparatus according to claim 5,
wherein the data collection shares work progress management data of other data collection apparatus each other via the support center.
